(19) United States
(12) Patent Application Publication
(10) Pub. No.: US 2008/0304453 A1
(43) Pub. Date: Dec. 11, 2008

(54) METHOD AND APPARATUS FOR SEQUENTIAL MESSAGES

(75) Inventors: Juan Carlos Zuniga, Montreal (CA); Khalid S. Hossain, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION., Wilmington, DE (US)

(21) Appl. No.: 12/133,141

(22) Filed: Jun. 4, 2008

Related U.S. Application Data
(60) Provisional application No. 60/942,546, filed on Jun. 7, 2007.

(51) Int. Cl. H04Q 7/00

(52) U.S. Cl. 370/331

(57) ABSTRACT

A method and apparatus for sequential measurement reporting in media independent handover communications are disclosed. In a first embodiment a measurement time field is added to existing IEEE 802.21 measurement report messages. In a second embodiment a measurement sequence number field is added to existing IEEE 802.21 measurement report messages. Optionally, the measurement time field, or sequence number field may be included in an IEEE 802.21 message.

### CROSS REFERENCE TO RELATED APPLICATIONS

This application claims the benefit of Provisional Application No. 60/942,546, filed on Jun. 7, 2007 which is incorporated by reference as if fully set forth.

### FIELD OF INVENTION

This application is related to wireless communications.

### BACKGROUND

The IEEE 802.21 Media Independent Handover standard defines mechanisms and procedures that aid in the execution and management of inter-access technology mobility management. IEEE 802.21 defines three main services available to Mobility Management applications. Referring to FIG. 1, these services are the Event Service 100, the Information Service 105 and the Command Service 110. These services aid in the management of handover operations, system discovery and system selection by providing information and triggers from lower layers 115 to upper layers 120, and lower layer commands from upper layers 120 to lower layers 115 via a media independent handover (MIH) function (MIHF) 125. While FIG. 1 shows MIHF 125 as a middle layer in a protocol stack, MIHF 125 may also be implemented as an MIH plane that is capable of exchanging information and triggers directly with each and every layer of a technology specific protocol stack.

Events may indicate changes in state and transmission behavior of the physical, data link and logical link layers, or predict state changes of these layers. The Event Service 100 may also be used to indicate management actions or command status on the part of the network or a management entity. The command service 110 enables higher layers to control the physical, data link, and logical link layers (referred to collectively as lower layers). The higher layers may control the reconfiguration or selection of an appropriate link through a set of handover commands. If a MIHF supports the command service, all MIH commands are mandatory in nature. When an MIHF receives a command, it is always expected to execute the command. The Information Service 105 provides a framework and corresponding mechanisms by which a MIHF entity may discover and obtain network information existing within a geographical area to facilitate handover.

IEEE 802.21 has defined several messages for periodically providing measurement reports. For example the link parameters report provides periodic measurements to other MIFH entities. However, the link parameters report does not provide any indication as to when a measurement was made, or the report was sent. An entity receiving these reports will therefore be unable to ensure that the measurements were received in the order they were made. Accordingly there is a need to provide a mechanism to indicate a sequence or time indicator with each measurement report. Similarly, there is a need to ensure that all IEEE 802.21 messages are received in the correct order.

### SUMMARY

A method and apparatus for sequential measurement reporting are disclosed. In a first embodiment a measurement time field is added to existing IEEE 802.21 measurement report messages. In a second embodiment a measurement sequence number field is added to existing IEEE 802.21 measurement report messages. Optionally, the measurement time field, or sequence number field may be included in an IEEE 802.21 message.

### BRIEF DESCRIPTION OF THE DRAWINGS

A more detailed understanding may be had from the following description, given by way of example in conjunction with the accompanying drawings wherein:

FIG. 1 is an IEEE 802.21 protocol architecture according to the prior art;

FIG. 2 shows the implementation of a mobile device and network supporting MIH functions;

FIG. 3 shows an example of a IEEE 802.21 message frame format including a Measurement Time Field; and

FIG. 4 shows an example of a IEEE 802.21 message frame format including a Measurement Sequence Field.

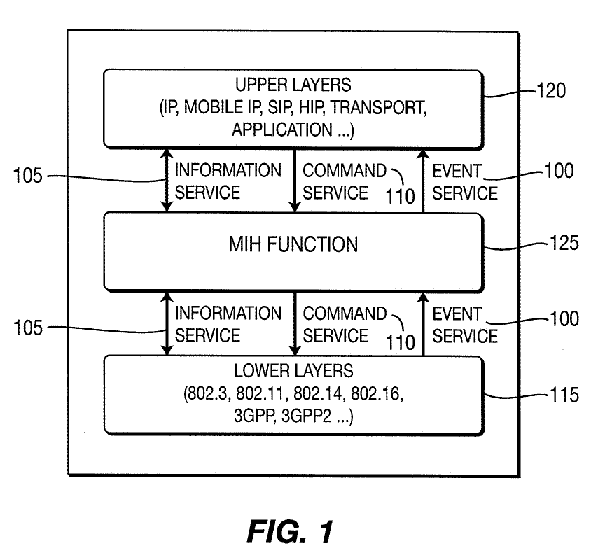

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of media independent handover device. When referred to hereafter, the terminology “base station” includes but is not limited to a Node-B, a site controller, an access point (AP), or any other type of interfacing device capable of operating in a wireless environment.

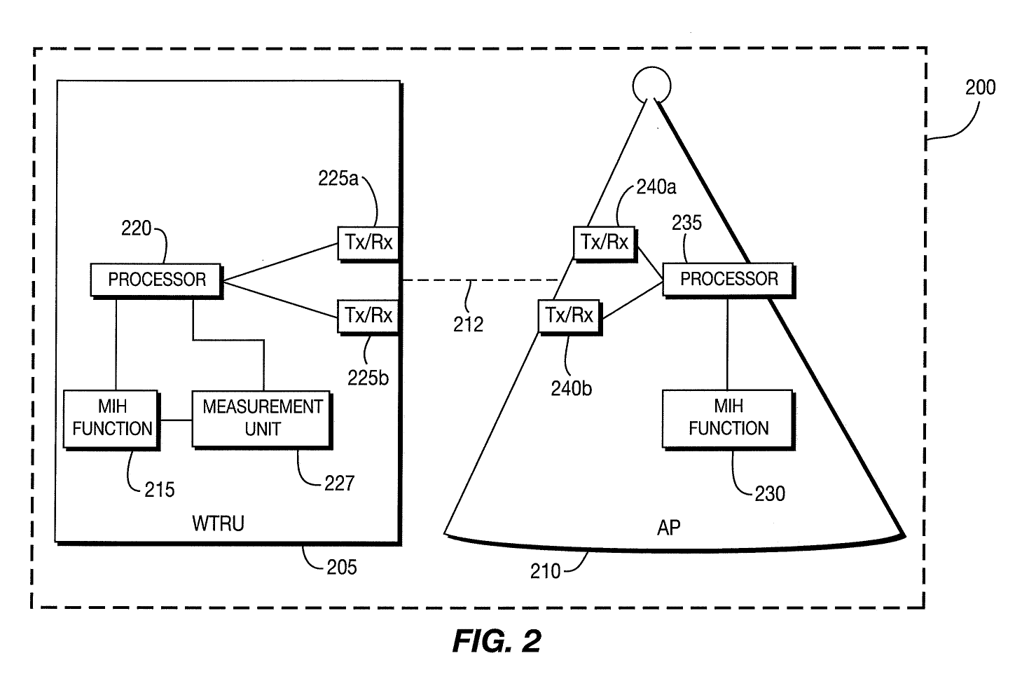

FIG. 2 is a block diagram of a wireless communication system 200 which includes a wireless transmit/receive unit 205 and an AP 1210. The WTRU 205 and the AP 210 communicate via a wireless communication link, 212.

As shown in FIG. 2, the WTRU 215 includes an MIHF 215, a processor 220, at least one transceiver (225a, 225b), and a measurement unit 227. The processor 220 is attached to the MIHF 215 and each of the transceivers 225a, 225b. The measurement unit 227 is attached to the processor 220 and the MIHF 215 and is configured to periodically perform measurements on various link parameters. The MIHF 215 is configured to carry out media independent handover related processes, including generating MIH measurement report messages which include measurement information and an associated time stamp or sequence number. Optionally, the MIHF 215 is also configured to generate any type of IEEE 802.21 message with an associated time stamp or sequence number.

Also shown in FIG. 2, the AP 210 includes an MIHF 230, a processor 235, at least one transceiver (240a, 240b). The processor 235 is attached to the MIH function 215 and each of the transceivers 225a, 225b. The MIHF 230 is configured to carry out media independent handover related processes, processing measurements reports received by the transceiver and assembling them in order based on the time stamp or sequence number. Optionally, the MIHF 230 may be located outside of the AP 210 in the network (not shown). For example, the AP 210 may be connected to an access router (not shown) which may house the MIHF 230.

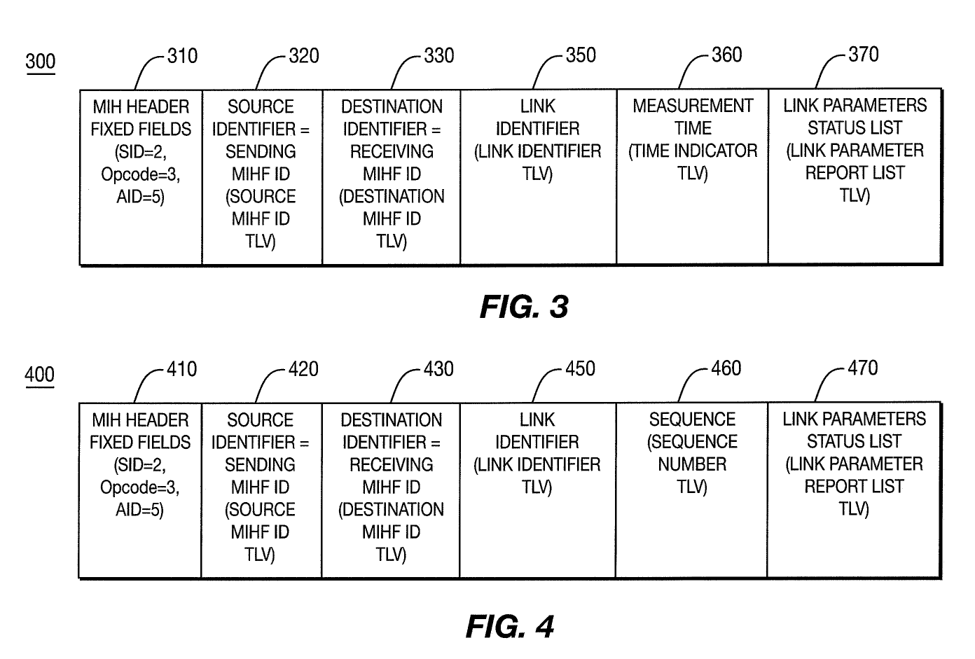

FIG. 3 is an example measurement report message 300 which may be generated and transmitted by the communication entities of FIG. 2. For the purpose of example, the measurement report message 300 includes an MIH Header Field 310, a Source Identifier field 320, a Destination Identifier field 330, a Transaction Identifier field 340, a Link Identifier field 350, a Measurement Time field 360, and a Link Parameter field 370. One of skill in the art would recognize that the disclosed Measurement Time field 360 could also be applied to any other type of IEEE 802.21 message, such as other Link event messages, Command messages, and Information service messages

The MIH Header field 310 carries the essential information that is present in every frame and is used for parsing and analyzing the MIH protocol frame and the Transaction Identifier field that is used for matching request, response and acknowledgement messages. The Source Identifier field 320 indicates the identity of the MIHF which sent the message. The Destination Identifier field 330 indicates the identity of the destination MIHF. The Link Identifier field indicates the link associated with the event. The Measurement Time field 360 indicates the time at which a measurement report message is related. The Link Parameter Status List field 370 contains the event-related information that is being reported

The Measurement Time field 360 may represent either an absolute time measurement or a time measurement relative to a to another known time. Table 1 shows an example of a possible definition for the Measured Time field 360. In Table 1 the measured time is represented using five octets, where the first octet represents the hour, the second octet represents the minute, the third octet represents seconds, and the forth and fifth octets are used in a union to represent milliseconds.

TABLE 1

| Type Name | Derived From | Definition | Valid Range |
|---|---|---|---|
| TIME_{—} | e.g. | Represents 5 octets, | First octet: |
| STAMP | LIST(CHAR(5)) | with the first for | 00-23 |
| | | hour, second for | Second octet: |
| | | minute, third for | 00-59 |
| | | seconds and fourth | Third octet: |
| | | and fifth used in a | 00-59 |
| | | union for | Fourth and fifth |
| | | milliseconds. | octet union: |
| | | | 000-999 |

In an alternative embodiment, Table 2 shows an example of a possible definition for the Measured Time field 360. In Table 2 the measured time is represented as four octets, where the first octet represents the hour, the second octet represents the minute, and the third and forth octets are used in a union to represent milliseconds.

TABLE 2

| Type Name | Derived From | Definition | Valid Range |
|---|---|---|---|
| TIME_{—} | e.g. | Represents 4 octets, | First octet: |
| STAMP | LIST(CHAR(4)) | with the first for | 00-23 |
| | | hour, second for | Second octet: |
| | | minute, third and | 00-59 |
| | | fourth in a union | Third and fourth |
| | | for milliseconds. | octet union: |
| | | | 00000-59999 |

In another alternative embodiment, Table 3 shows an example of a possible definition for the Measured Time field 360. In Table 3 the measured time is represented as two or more octets showing a differential in time in milliseconds between the measurement and known reference point, such as registration, or previous measurement.

TABLE 3

| Type Name | Derived From | Definition | Valid Range |
|---|---|---|---|
| TIME_{—} | e.g. | Represents 2 (or | 0-65535 (if two |
| STAMP | INTEGER(2) | more) octets to | octets are used) |
| | | show time in e.g. | |
| | | milliseconds from a | |
| | | reference point | |
| | | (e.g. registration, | |
| | | first measurement | |
| | | report, some | |
| | | defined event or | |
| | | some fixed time) | |

In another alternative embodiment, Table 4 shows an example of a possible definition for the Measured Time field 360. In Table 4 the measured time is represented as two or more octets to show a central processing unit (CPU) clock time of a sending peer defined in Time Units (TU), which could be defined as multiples of ms, μs, etc.

TABLE 4

| Type Name | Derived From | Definition | Valid Range |
|---|---|---|---|
| TIME_{—} | e.g. | Represents 2 (or | 0-65535 (if two |
| STAMP | INTEGER(2) | more) octets to show | octets are used) |
| | | CPU clock time (in | |
| | | suitable units, e.g. | |
| | | ms, μs, TU, etc.) of | |
| | | the sending peer | |

FIG. 4 shows an example measurement report message 400 which may be generated and transmitted by the communication entities of FIG. 2. For the purpose of example, the measurement report message 400 includes an MIH Header Field 310, a Source Identifier field 420, a Destination Identifier field 430, a Link Identifier field 450, a Measurement Sequence field 360, and a Link Parameter field 470. One of skill in the art would recognize that the disclosed Measurement Sequence field 460 could also be applied to any other type of measurement report message, such as other Link event messages, Command messages, and Information service messages.

TABLE 5

| Type Name | Derived From | Definition | Valid Range |
|---|---|---|---|
| SEQUENCE | e.g. | Represents | 0-65535 |
| | INTEGER(2) | sequence of any | |
| | | event such as | |
| | | measurement | |
| | | report. | |

Table 5 shows an example of a possible definition for the Sequence field 460. The Sequence field 460 will be a number which represents a sequence of each event such as each measurement or each measurement report. The Sequence field 460 allows holes in received messages to be detected as missing numbers in the sequence. Any dropped event or message can be detected by the AP 210. Optionally, the additional information provided or derived by from the Sequence 460 field may be applied to a handover algorithm.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A wireless transmit/receive unit (WTRU) comprising:
a media independent handover function (MIHF) configured to generate a message, including a time information field; and
a transmitter configured to transmit the message.

2. The WTRU of claim 1 wherein the time information field is a time stamp.

3. The WTRU of claim 1 wherein the time information field is a sequence number.

4. The WTRU of claim 2 wherein the time information field is five octets including:
a first octet representing hours;
a second octet representing minutes;
a third octet representing seconds; and
a forth and fifth octet in union representing milliseconds.

5. The WTRU of claim 2 wherein the time information field is four octets including:
a first octet representing hours;
a second representing minutes; and
a third and forth octet in union representing milliseconds.

6. The WTRU of claim 2 wherein the time information field is two or more octets, the two or more octets including a representation of a central processing unit clock time of a peer WTRU.

7. The WTRU of claim 2 wherein the time information field includes two or more octets representing a differential in time between a time the message is transmitted and a known reference time.

8. The WTRU of claim 3 wherein the time sequence number represents a sequence of a measurement event.

9. A method of providing sequential messages in a media independent handover related communication, the method comprising:
generating a media independent handover message message, including a time information field; and
transmitting the message.

10. The method of claim 9 wherein the time information field is a time stamp.

11. The method of claim 9 wherein the time information field is a sequence number.

12. The method of claim 10 wherein the time information field is five octets including:
a first octet representing hours;
a second octet representing minutes;
a third octet representing seconds; and
a forth and fifth octet in union representing milliseconds.

13. The method of claim 10 wherein the time information field is four octets including:
a first octet representing hours;
a second representing minutes; and
a third and forth octet in union representing milliseconds.

14. The method of claim 10 wherein the time information field is two or more octets, the two or more octets including a representation of a central processing unit clock time of a peer WTRU.

15. The method of claim 10 wherein the time information field includes two or more octets representing a differential in time between a time the message is transmitted and a known reference time.
